(19) United States
(12) Patent Application Publication
(10) Pub. No.: US 2026/0129498 A1
(43) Pub. Date: May 7, 2026

(54) APPARATUS AND METHOD OF WIRELESS COMMUNICATION

(71) Applicant: Guangdong OPPO Mobile Telecommunications Corp., Ltd., Dongguan (CN)

(72) Inventor: Li GUO, Allen, TX (US)

(73) Assignee: Guangdong OPPO Mobile Telecommunications Corp., Ltd., Dongguan (CN)

(21) Appl. No.: 19/438,929

(22) Filed: Jan. 2, 2026

Related U.S. Application Data
(63) Continuation of application No. PCT/CN2024/104480, filed on Jul. 9, 2024.
(60) Provisional application No. 63/526,883, filed on Jul. 14, 2023.

(51) Int. Cl. H04W 24/10

(52) U.S. Cl. CPC H04W 24/10

(57) ABSTRACT

A method of wireless communication of a user equipment (UE) includes that: a request to measure one or more offset values between a first reference signal (RS) associated with a first transmission/reception point (TRP) and a second RS associated with a second TRP is received from a base station, and a measurement report is transmitted to the base station, wherein the measurement report indicates the one or more offset values between the first RS associated with the first TRP and the second RS associated with the second TRP.

### CROSS-REFERENCE TO RELATED APPLICATION

This is a continuation application of International Patent Application No. PCT/CN2024/104480, filed on July 09, 2024, which claims priority to US application No. 63/526,883, filed on July 14, 2023, the disclosures of the above are hereby incorporated by reference in their entirety.

### BACKGROUND

The current coherent joint transmission assumes transmission/reception points (TRPs) are perfectly synchronized with respect to both time and frequency. But in real systems, there exists timing offset and frequency offset between TRPs. Those imperfect factors would impair a performance coherent joint transmission because the assumption of current design is not satisfied. Thus, there is an unmet need for a mechanism that enables TRPs to compensate the timing offset and frequency offset.

Therefore, there is a need for apparatuses and methods of wireless communication.

### SUMMARY

The present disclosure relates to the field of communication systems, and more particularly, to apparatuses and methods of wireless communication. An object of the present disclosure is to propose apparatuses and methods of wireless communication, which can solve issues in the prior art and other issues, provide an exemplary technique by which a user equipment (UE) may measure and report relative time and frequency synchronization offset to assist inter-transmission/reception point (TRP) calibration, adjust timing and frequency synchronization between TRPs, and/or improve a performance coherent joint transmission.

In a first aspect of the present disclosure, a method of wireless communication of a user equipment (UE) includes receiving a request to measure one or more offset values between a first reference signal (RS) associated with a first transmission/reception point (TRP) and a second RS associated with a second TRP from a base station; and transmitting a measurement report to the base station, wherein the measurement report indicates the one or more offset values between the first RS associated with the first TRP and the second RS associated with the second TRP.

In a second aspect of the present disclosure, a UE includes a memory, a transceiver, and a processor coupled to the memory and the transceiver. The UE is configured to receive a request to measure one or more offset values between a first reference signal (RS) associated with a first transmission/reception point (TRP) and a second RS associated with a second TRP from a base station; and transmit a measurement report to the base station, wherein the measurement report indicates the one or more offset values between the first RS associated with the first TRP and the second RS associated with the second TRP.

In a third aspect of the present disclosure, a base station includes a memory, a transceiver, and a processor coupled to the memory and the transceiver. The base station is configured to: transmit a request to measure one or more offset values between a first reference signal (RS) associated with a first transmission/reception point (TRP) and a second RS associated with a second TRP to a user equipment; and receive a measurement report from the user equipment, wherein the measurement report indicates the one or more offset values between the first RS associated with the first TRP and the second RS associated with the second TRP.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1A is a schematic diagram of an example of multi-transmission/reception point (TRP) based non-coherent joint transmission.

FIG. 1B is a schematic diagram of another example of multi-TRP transmission.

FIG. 2 is a block diagram of one or more user equipments (UEs) and a base station of communication in a communication network system according to an embodiment of the present disclosure.

FIG. 3 is a block diagram of a UE according to an embodiment of the present disclosure.

FIG. 4 is a block diagram of a UE according to an embodiment of the present disclosure.

FIG. 5 is a flowchart illustrating a method of wireless communication performed by a UE according to an embodiment of the present disclosure.

FIG. 6 is a block diagram of a base station according to an embodiment of the present disclosure.

FIG. 7 is a block diagram of a base station according to an embodiment of the present disclosure.

FIG. 8 is a flowchart illustrating a method of wireless communication performed by a base station according to an embodiment of the present disclosure.

FIG. 9 is a block diagram of an example of a computing device according to an embodiment of the present disclosure.

FIG. 10 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5th generation (5G) system (may also be called a new radio (NR) system) or other communication systems, etc.

Optionally, a base station mentioned in the embodiments of the present application can provide a communication coverage for a specific geographic area and can communicate with a user equipment (UE) located in the coverage area. Optionally, the base station may be a gNB, a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN).

A user equipment (UE) may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved public land mobile network (PLMN), etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

New radio (NR) system introduces multi-transmission/reception point (TRP) based non-coherent joint transmission and also coherent joint transmission. In non-coherent joint transmission, multiple TRPs are connected through one or more backhaul links for coordination. The backhaul link can be ideal or non-ideal. In the case of ideal backhaul communication, the TRPs can exchange dynamic physical downlink shared channel (PDSCH) scheduling information with short latency and thus different TRPs can coordinate the PDSCH transmission per PDSCH transmission. While, in the case of non-ideal backhaul communication, the information exchange between TRPs has an undesirable latency, and thus, the coordination between TRPs can only be semi-static or static.

In non-coherent joint transmission, different TRPs use different physical downlink control channels (PDCCHs) to schedule the PDSCH transmission independently. Each TRP can send one downlink control information (DCI) on the PDCCH to schedule one PDSCH transmission. PDSCHs from different TRPs can be scheduled in the same slot or different slots. Two different PDSCH transmissions from different TRPs can be fully overlapped or partially overlapped in PDSCH resource allocation.

To support multi-TRP based non-coherent joint transmission, a user equipment (UE) is requested to receive PDCCH from multiple TRPs, and then, receive PDSCH sent from multiple TRPs. For each PDSCH transmission, the UE can feedback a hybrid automatic repeat request (HARQ)-acknowledgement (ACK) information to the network. In multi-TRP transmission, the UE can feedback the HARQ-ACK information for each PDSCH transmission to the TRP transmitting the PDSCH. The UE can also feedback the HARQ-ACK information for a PDSCH transmission sent from any TRP to one particular TRP.

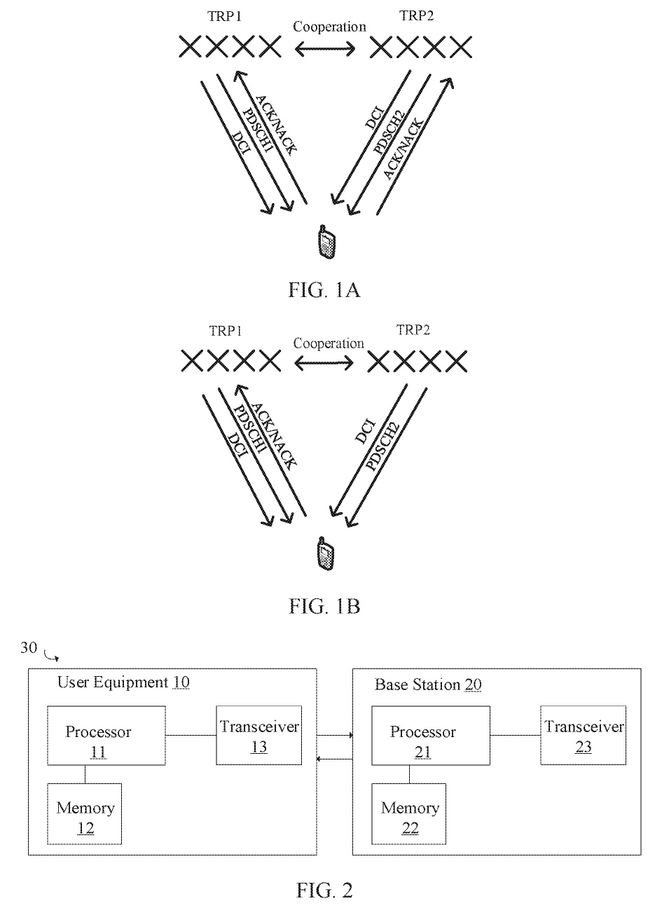

An example of multi-TRP based non-coherent joint transmission is illustrated in FIG. 1A. A UE receives a PDSCH based on non-coherent joint transmission from two TRPs: TRP1 and TRP2. As illustrated in FIG. 1A, the TRP1 sends one downlink control information (DCI) to schedule the transmission of PDSCH1 to the UE, and TRP2 sends one DCI to schedule the transmission of PDSCH2 to the UE. At the UE side, the UE receives and decodes the DCI from both TRPs. Based on the DCI from TRP1, the UE receives and decodes PDSCH1, and based on the DCI from TRP2, the UE receives and decodes PDSCH2. In the example illustrated in FIG. 1A, the UE reports HARQ-ACK for PDSCH1 and PDSCH2 to the TRP1 and TRP2, respectively. TRP1 and TRP2 use different control resource sets (CORESETs) and search spaces to transmit DCI scheduling PDSCH transmission to the UE. Therefore, a network can configure multiple CORESETs and search spaces. Each TRP can be associated with one or more CORESETs and also the related search spaces. With such a configuration, the TRP would use the associated CORESET to transmit DCI to schedule a PDSCH transmission to the UE. The UE can be requested to decode the DCI in CORESETs associated with either TRP to obtain PDSCH scheduling information.

Another example of multi-TRP transmission is illustrated in FIG. 1B. A UE receives a PDSCH based on non-coherent joint transmission from two TRPs: TRP1 and TRP2. As illustrated in FIG. 1B, the TRP1 sends one DCI to schedule the transmission of PDSCH1 to the UE, and TRP2 sends one DCI to schedule the transmission of PDSCH2 to the UE. At the UE side, the UE receives and decodes the DCI from both TRPs. Based on the DCI from TRP1, the UE receives and decodes PDSCH1, and based on the DCI from TRP2, the UE receives and decodes PDSCH 2. In the example illustrated in FIG. 1B, the UE reports HARQ-ACK for both PDSCH1 and PDSCH2 to the TRP, which is different from the HARQ-ACK reporting in the example illustrated in FIG. 1A. The example shown in FIG. 1B needs ideal backhaul between TRP 1 and TRP 2, while the example illustrated in FIG. 1A can be deployed in the scenarios that the backhaul between TRP1 and TRP2 is ideal or non-ideal.

NR supports the function of timing advance for uplink transmission, where a base station such as gNB sends a special command to a UE to enable the UE to adjust its uplink (UL) transmission so that the uplink transmission arrives at the gNB side at the right timing. Such UL adjustment applies to physical uplink shared channel (PUSCH), physical uplink control channel (PUCCH), and sounding reference signal (SRS) transmission. The timing advance information is delivered to a UE through two methods. The first method is a random access channel (RACH) response (RAR). The gNB can indicate one timing advance value in the RAR message to the UE. The second method is a medium access control (MAC) control element (CE) command. The gNB can indicate one timing advance value in a MAC CE command, and upon receiving the MAC CE command, the UE can be requested to apply the indicated timing advance value.

Coherent joint transmission is different from non-coherent joint transmission. In coherent joint transmission, multiple TRPs are connected through a backhaul link for coordination, and the backhaul link can only be ideal. For each DL transmission, the TRP transmits the same PDCCH and PDSCH with coherent precoders. To support coherent joint transmission, the TRPs should have perfect timing synchronization and frequency synchronization. This condition ensures the signals from different TRPs are combined coherently at the UE side.

To overcome these and other challenges, some embodiments of the present disclosure provide an exemplary technique by which the UE may measure and report relative time and frequency synchronization offset to assist inter-TRP calibration.

FIG. 2 illustrates that, in some embodiments, one or more user equipments (UEs) 10 and a base station (e.g., next generation NodeB (gNB) or eNB) 20 of communication in a communication network system 30 (e.g., an NR system) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the transceiver 13 is configured to receive a request to measure one or more offset values between a first reference signal (RS) associated with a first transmission/reception point (TRP) and a second RS associated with a second TRP from the base station 20, and the transceiver 13 is configured to transmit a measurement report to the base station 20, wherein the measurement report indicates the one or more offset values between the first RS associated with the first TRP and the second RS associated with the second TRP. This can solve issues in the prior art and other issues, provide an exemplary technique by which a user equipment (UE) may measure and report relative time and frequency synchronization offset to assist inter-transmission/reception point (TRP) calibration, adjust timing and frequency synchronization between TRPs, and/or improve a performance coherent joint transmission.

In some embodiments, the transceiver 23 is configured to transmit a request to measure one or more offset values between a first reference signal (RS) associated with a first transmission/reception point (TRP) and a second RS associated with a second TRP to the user equipment 10, and the transceiver 23 is configured to receive a measurement report from the user equipment 10, wherein the measurement report indicates the one or more offset values between the first RS associated with the first TRP and the second RS associated with the second TRP. This can solve issues in the prior art and other issues, provide an exemplary technique by which a user equipment (UE) may measure and report relative time and frequency synchronization offset to assist inter-transmission/reception point (TRP) calibration, adjust timing and frequency synchronization between TRPs, and/or improve a performance coherent joint transmission.

FIG. 3 illustrates an example of a UE 200 according to an embodiment of the present application. The UE 200 is configured to implement some embodiments of the disclosure. Some embodiments of the disclosure may be implemented into the UE 200 using any suitably configured hardware and/or software. The UE 200 includes a receiver 201 and a transmitter 202. The receiver 201 is configured to receive a request to measure one or more offset values between a first reference signal (RS) associated with a first transmission/reception point (TRP) and a second RS associated with a second TRP from a base station, and the transmitter 202 is configured to transmit a measurement report to the base station, wherein the measurement report indicates the one or more offset values between the first RS associated with the first TRP and the second RS associated with the second TRP. This can solve issues in the prior art and other issues, provide an exemplary technique by which a user equipment (UE) may measure and report relative time and frequency synchronization offset to assist inter-transmission/reception point (TRP) calibration, adjust timing and frequency synchronization between TRPs, and/or improve a performance coherent joint transmission.

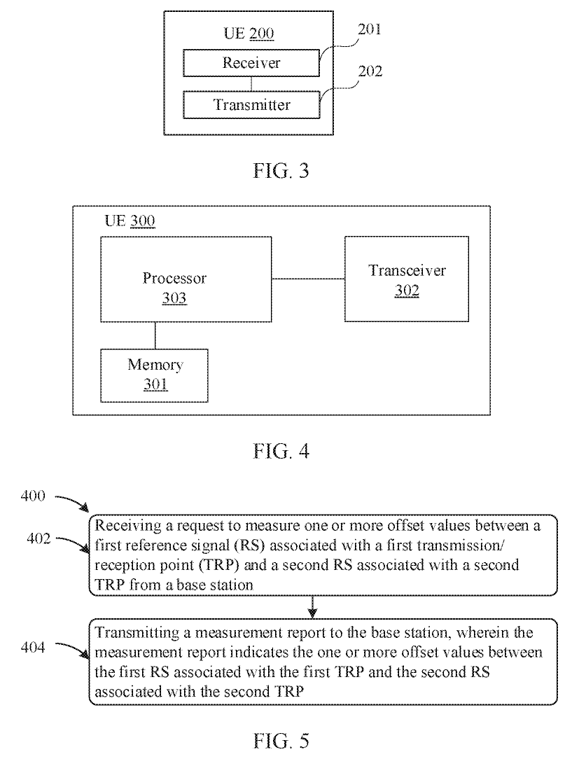

FIG. 4 illustrates an example of a UE 300 according to an embodiment of the present disclosure. The UE 300 is configured to implement some embodiments of the disclosure. Some embodiments of the disclosure may be implemented into the UE 300 using any suitably configured hardware and/or software. The UE 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the transceiver 302 is configured to receive a request to measure one or more offset values between a first reference signal (RS) associated with a first transmission/reception point (TRP) and a second RS associated with a second TRP from a base station, and the transceiver 302 is configured tot ransmit a measurement report to the base station, wherein the measurement report indicates the one or more offset values between the first RS associated with the first TRP and the second RS associated with the second TRP. This can solve issues in the prior art and other issues, provide an exemplary technique by which a user equipment (UE) may measure and report relative time and frequency synchronization offset to assist inter-transmission/reception point (TRP) calibration, adjust timing and frequency synchronization between TRPs, and/or improve a performance coherent joint transmission.

FIG. 5 is an example of a method 400 of wireless communication performed by a UE according to an embodiment of the present disclosure. The method 400 of wireless communication performed by a UE is configured to implement some embodiments of the disclosure. Some embodiments of the disclosure may be implemented into the method 400 of wireless communication performed by a UE using any suitably configured hardware and/or software. In some embodiments, the method 400 of wireless communication performed by a UE includes: an operation 402, receiving a request to measure one or more offset values between a first reference signal (RS) associated with a first transmission/reception point (TRP) and a second RS associated with a second TRP from a base station, and an operation 404, transmitting a measurement report to the base station, wherein the measurement report indicates the one or more offset values between the first RS associated with the first TRP and the second RS associated with the second TRP. This can solve issues in the prior art and other issues, provide an exemplary technique by which a user equipment (UE) may measure and report relative time and frequency synchronization offset to assist inter-transmission/reception point (TRP) calibration, adjust timing and frequency synchronization between TRPs, and/or improve a performance coherent joint transmission.

In some embodiments, the method further includes measuring the first RS associated with the first TRP and the second RS associated with the second TRP. In some embodiments, the method further includes calculating the one or more offset values between the first RS associated with the first TRP and the second RS associated with the second TRP. In some embodiments, the one or more offset values include one or more time difference values, one or more frequency offset values, or one or more phase offset values. In some embodiments, the first RS includes a first channel state information reference signal (CSI-RS) resource or first second synchronization signal (SS)/physical broadcast channel (PBCH) blocks, and the second RS includes a second CSI-RS resource or second SS/PBCH blocks. In some embodiments, the measurement report is relative to an arrival time of the first CSI-RS resource and the second CSI-RS resource, an arrival time of the first SS/PBCH blocks and the second SS/PBCH blocks, a frequency offset of the first CSI-RS resource and the second CSI-RS resource, a frequency offset of the first SS/PBCH blocks and the second SS/PBCH blocks, a phase of the first CSI-RS resource and the second CSI-RS resource, or a phase of the first SS/PBCH blocks and the second SS/PBCH blocks.

In some embodiments, the first CSI-RS resource is configured with multiple antenna ports, and the second CSI-RS resource is configured with multiple antenna ports. In some embodiments, the measurement report is relative to an indicator of the first CSI-RS resource and the second CSI-RS resource, an indicator of the first SS/PBCH block and the second SS/PBCH block, or an indicator of a first CSI-RS resource antenna port index and a second CSI-RS resource antenna port index. In some embodiments, transmitting the measurement report to the base station includes transmitting the measurement report to the base station through a media access control (MAC) control element (CE) message, an uplink control information (UCI) through a physical uplink control channel (PUCCH) transmission, a periodic manner, a semi-persistent manner, an aperiodic manner, or a UE-driven mode.

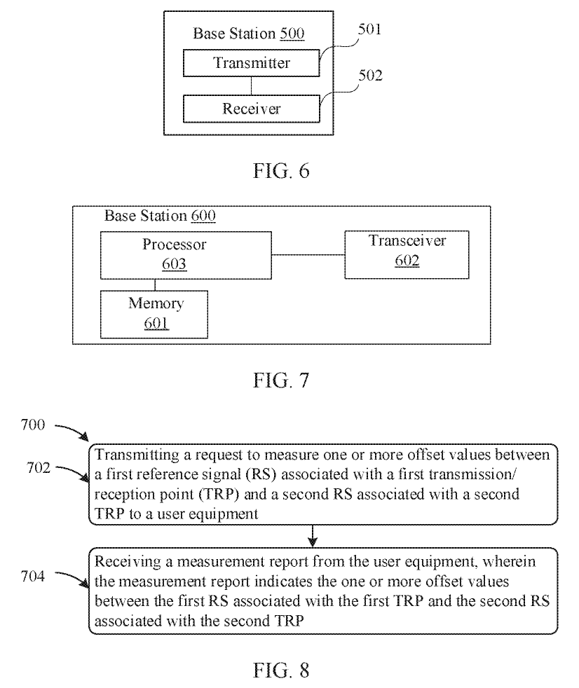

FIG. 6 illustrates an example of base station 500 according to an embodiment of the present application. The base station 500 is configured to implement some embodiments of the disclosure. Some embodiments of the disclosure may be implemented into the base station 500 using any suitably configured hardware and/or software. The base station 500 includes a transmitter 501 and a reveiver 502. The transmitter 501 is configured to transmit a request to measure one or more offset values between a first reference signal (RS) associated with a first transmission/reception point (TRP) and a second RS associated with a second TRP to a user equipment. The receiver 502 is configured to receive a measurement report from the user equipment, wherein the measurement report indicates the one or more offset values between the first RS associated with the first TRP and the second RS associated with the second TRP. This can solve issues in the prior art and other issues, provide an exemplary technique by which a user equipment (UE) may measure and report relative time and frequency synchronization offset to assist inter-transmission/reception point (TRP) calibration, adjust timing and frequency synchronization between TRPs, and/or improve a performance coherent joint transmission.

FIG. 7 illustrates an example of a base station 600 according to an embodiment of the present disclosure. The base station 600 is configured to implement some embodiments of the disclosure. Some embodiments of the disclosure may be implemented into the base station 600 using any suitably configured hardware and/or software. The base station 600 may include a memory 601, a transceiver 602, and a processor 603 coupled to the memory 601 and the transceiver 602. The processor 603 may be configured to implement proposed functions, procedures and/or methods described in this description. Layers of radio interface protocol may be implemented in the processor 603. The memory 601 is operatively coupled with the processor 603 and stores a variety of information to operate the processor 603. The transceiver 602 is operatively coupled with the processor 603, and the transceiver 602 transmits and/or receives a radio signal. The processor 603 may include application-specific integrated circuit (ASIC), other chipset, logic circuit and/or data processing device. The memory 601 may include read-only memory (ROM), random access memory (RAM), flash memory, memory card, storage medium and/or other storage device. The transceiver 602 may include baseband circuitry to process radio frequency signals. When the embodiments are implemented in software, the techniques described herein can be implemented with modules (e.g., procedures, functions, and so on) that perform the functions described herein. The modules can be stored in the memory 601 and executed by the processor 603. The memory 601 can be implemented within the processor 603 or external to the processor 603 in which case those can be communicatively coupled to the processor 603 via various means as is known in the art.

In some embodiments, the transceiver 602 is configured to transmit a request to measure one or more offset values between a first reference signal (RS) associated with a first transmission/reception point (TRP) and a second RS associated with a second TRP to a user equipment, and the transceiver 602 is configured to receive a measurement report from the user equipment, wherein the measurement report indicates the one or more offset values between the first RS associated with the first TRP and the second RS associated with the second TRP. This can solve issues in the prior art and other issues, provide an exemplary technique by which a user equipment (UE) may measure and report relative time and frequency synchronization offset to assist inter-transmission/reception point (TRP) calibration, adjust timing and frequency synchronization between TRPs, and/or improve a performance coherent joint transmission.

FIG. 8 is an example of a method 700 of wireless communication performed by a base station according to an embodiment of the present disclosure. The method 700 of wireless communication performed by the base station is configured to implement some embodiments of the disclosure. Some embodiments of the disclosure may be implemented into the method 700 of wireless communication performed by the base station using any suitably configured hardware and/or software. In some embodiments, the method 700 of wireless communication performed by the base station includes: an operation 702, transmitting a request to measure one or more offset values between a first reference signal (RS) associated with a first transmission/reception point (TRP) and a second RS associated with a second TRP to a user equipment, and an operation 704, receiving a measurement report from the user equipment, wherein the measurement report indicates the one or more offset values between the first RS associated with the first TRP and the second RS associated with the second TRP. This can solve issues in the prior art and other issues, provide an exemplary technique by which a user equipment (UE) may measure and report relative time and frequency synchronization offset to assist inter-transmission/reception point (TRP) calibration, adjust timing and frequency synchronization between TRPs, and/or improve a performance coherent joint transmission.

In some embodiments, the method further includes performing an inter-TRP calibration of the first TRP and the second TRP based on the measurement report. In some embodiments, the one or more offset values include one or more time difference values, one or more frequency offset values, or one or more phase offset values. In some embodiments, the first RS includes a first channel state information reference signal (CSI-RS) resource or first second synchronization signal (SS)/physical broadcast channel (PBCH) blocks, and the second RS includes a second CSI-RS resource or second SS/PBCH blocks. In some embodiments, the measurement report is relative to an arrival time of the first CSI-RS resource and the second CSI-RS resource, an arrival time of the first SS/PBCH blocks and the second SS/PBCH blocks, a frequency offset of the first CSI-RS resource and the second CSI-RS resource, a frequency offset of the first SS/PBCH blocks and the second SS/PBCH blocks, a phase of the first CSI-RS resource and the second CSI-RS resource, or a phase of the first SS/PBCH blocks and the second SS/PBCH blocks.

In some embodiments, the first CSI-RS resource is configured with multiple antenna ports, and the second CSI-RS resource is configured with multiple antenna ports. In some embodiments, the measurement report is relative to an indicator of the first CSI-RS resource and the second CSI-RS resource, an indicator of the first SS/PBCH block and the second SS/PBCH block, or an indicator of a first CSI-RS resource antenna port index and a second CSI-RS resource antenna port index. In some embodiments, receiving the measurement report from the UE includes receiving the measurement report from the UE through a media access control (MAC) control element (CE) message, an uplink control information (UCI) through a physical uplink control channel (PUCCH) transmission, a periodic manner, a semi-persistent manner, an aperiodic manner, or a UE-driven mode.

### Exemplary Technical Solutions:

In some embodiments, a UE can be requested to measure the time difference between downlink RS of different TRPs and then the UE can be requested to report the measurement result to the gNB. The UE can be requested to measure the offset of carrier frequency between downlink reference signal (RS) of different TRPs and then report the measurement results to the gNB. The UE can be requested to measure phase offset between downlink RS of different TRPs and then report the measurement results to the gNB. The downlink RS for the measurement can be CSI-RS resources or SS/PBCH blocks. The UE can be configured with K CSI-RS resources. The UE can be requested to measure the arrival time of each CSI-RS resource, and then, the UE can be requested to calculate the time difference of each CSI-RS resource with a reference to a first CSI-RS resource. For each CSI-RS resource, the time difference can be calculated as the arrival time measured from this CSI-RS resource (e.g., the arrival time measured from the first CSI-RS resource). The UE can be requested to report the time difference results to the gNB. The UE can be requested to measure the carrier frequency of each CSI-RS resource and then the UE can be requested to calculate the frequency offset of each CSI-RS resource with a reference to a first CSI-RS resource, where the frequency offset can be calculated as the carrier frequency measured from a CSI-RS resource (e.g., the carrier frequency measured from the first CSI-RS resource).

In some embodiments, the UE can be requested to report the frequency offset results to the gNB. The UE can be requested to measure the phase of each CSI-RS resource, and then, the UE can be requested to calculate the differential phase of each CSI-RS resource with a reference to a first CSI-RS resource. The UE can be requested to report the differential phase results to the gNB. The UE can be configured with K SS/PBCH blocks and the UE can be requested to measure and report measurement results according to the above methods.

In some embodiments, the UE can be configured with a CSI-RS resource with multiple antenna ports. The UE can be requested to measure and report the measurement results of each antenna port of the CSI-RS resource according to the above methods. The UE can be requested to report an indicator of CSI-RS resource, or an indicator of SS/PBCH block or an indicator of CSI-RS resource antenna port index, which is used as reference to calculate the measurement results.

In some embodiments, the UE can be requested to report the above measurement results through a MAC CE message. The UE can be requested to report the above measurement results through uplink control information (UCI) through PUCCH transmission. The UE can be requested to report the above measurement results through a periodic manner. The UE can be requested to report the above measurement results through a semi-persistent manner. The UE can be requested to report the above measurement results through an aperiodic manner. The UE can be configured to report the above measurement results through a UE-driven mode, where the UE reports the above measurement results when some condition is satisfied. The condition can be provided by the gNB to the UE.

In some embodiments, in a first method, the UE can be configured to measure a set of N CSI-RS resources or SS/PBCH blocks. The measurement result can be relative to the arrival time of two CSI-RS resources or SS/PBCH blocks, relative phase of two CSI-RS resources or SS/PBCH blocks, or frequency offset between two CSI-RS resources or SS/PBCH blocks, and then the UE can be requested report the measurement results to the gNB. For measurement result of a CSI-RS resource or SS/PBCH block, the UE can be requested to measure and calculate the measurement result with a reference to a reference CSI-RS resource or reference SS/PBCH block. In one example, the gNB can indicate the reference CSI-RS or reference SS/PBCH block to the UE. In one example, the UE can determine one of the configured N CSI-RS resources or SS/PBCH blocks to be the reference CSI-RS resource or reference SS/PBCH block, and the UE can report the indicator of the determined reference CSI-RS resource or reference SS/PBCH block to the gNB.

In a first example, the UE can be configured with N CSI-RS resources or SS/PBCH blocks to measure the relative arrival time of CSI-RS resources or SS/PBCH blocks. The UE can be requested to report the following information: a relative arrival time value of the first CSI-RS resource or SS/PBCH block of the configured N CSI-RS resources or SS/PBCH blocks, a relative arrival time value of the entry CSI-RS resource or SS/PBCH block of the configured N CSI-RS resources or SS/PBCH blocks, …, and/or a relative arrival time value of the N-th CSI-RS resource or SS/PBCH block of the configured N CSI-RS resources or SS/PBCH blocks.

In some embodiments, if a relative arrival time value of a CSI-RS resource or SS/PBCH is set to some particular value (e.g., 0), this indicates that the corresponding CSI-RS resource or SS/PBCH block is used as the reference CSI-RS resource or reference SS/PBCH block for calculating all the relative arrival time values in the reporting instance. In the first example, the measurement result can also be relative phase or frequency offset.

In a second example, the UE can be configured with a list of N CSI-RS resources or SS/PBCH blocks to measure the relative arrival time of CSI-RS resources or SS/PBCH blocks. The gNB can also configure that one of N CSI-RS resources or SS/PBCH block is reference CSI-RS resource or SS/PBCH block for the UE to calculate the measurement result of relative arrival time. The UE can be requested to report the following information: a relative arrival time value corresponding the first entry of the configured list of CSI-RS resources or SS/PBCH blocks with excluding the CSI-RS resources or SS/PBCH block used as reference, a relative arrival time value corresponding the second entry of the configured list of CSI-RS resources or SS/PBCH blocks with excluding the CSI-RS resources or SS/PBCH block used as reference, …, and/or a relative arrival time value corresponding the (N-1)-th entry of the configured list of CSI-RS resources or SS/PBCH blocks with excluding the CSI-RS resources or SS/PBCH block used as reference.

In this example method, the measurement result can also be relative phase or frequency offset.

In a third example, the UE can be configured with a list of N CSI-RS resources or SS/PBCH blocks to measure the relative arrival time of CSI-RS resources or SS/PBCH blocks. The UE can be requested to determine one reference CSI-RS resource or SS/PBCH block among the configured N CSI-RS resources or SS/PBCH blocks. The UE can be requested to report the following information: one indicator of a CSI-RS resource or SS/PBCH block to indicate the reference CSI-RS resource or reference SS/PBCH block, a relative arrival time value corresponding the first entry of the configured list of CSI-RS resources or SS/PBCH blocks with excluding the CSI-RS resources or SS/PBCH block used as reference, a relative arrival time value corresponding the second entry of the configured list of CSI-RS resources or SS/PBCH blocks with excluding the CSI-RS resources or SS/PBCH block used as reference, …, and/or a relative arrival time value corresponding the (N-1)-th entry of the configured list of CSI-RS resources or SS/PBCH blocks with excluding the CSI-RS resources or SS/PBCH block used as reference. In some embodiments, in this example method, the measurement result can also be relative phase or frequency offset.

In some embodiments, in a second method, the UE can be requested to measure relative arrival time of each antenna ports of one CSI-RS resource. The gNB can provide the configuration of a first CSI-RS resource with N antenna ports to the UE. The UE can be requested to measure and report the relative arrival time between two antenna ports of the first CSI-RS resource. The UE can be requested to measure and report the relative phase between two antenna ports of the first CSI-RS resource. The UE can be requested to measure and report the frequency offset between two antenna ports of the first CSI-RS resource. For each measurement result, the UE can be requested to measure and calculate the measurement result with a reference to a reference antenna port of the first CSI-RS resource. In one example, the gNB can indicate the reference CSI-RS antenna port to the UE. In one example, the UE can determine one CSI-RS antenna port to be the reference CSI-RS antenna port, and the UE can report the indicator of the determined reference CSI-RS antenna port.

In an example, the UE can be configured with a first CSI-RS resources with N ports to measure the relative arrival time of CSI-RS antenna ports. The UE can be requested to report the following information: a relative arrival time value of the first antenna port of the first CSI-RS resource, a relative arrival time value of the second antenna port of the first CSI-RS resource, …, and/or a relative arrival time value of the N-th antenna port of the first CSI-RS resource.

In some embodiments, if a relative arrival time value corresponding to one antenna port is set to some particular value (e.g., 0), this indicates that the corresponding CSI-RS antenna port is used as the reference antenna port for calculating all the relative arrival time values in the reporting instance. In this example, the measurement result can also be relative phase or frequency offset between antenna ports.

In an example, the UE can be configured with a first CSI-RS resource with N antenna ports to measure the relative arrival time of antenna ports. The gNB can also indicate that one CSI-RS antenna port is the reference antenna port for the UE to calculate the measurement result of relative arrival time. The UE can be requested to report the following information: a relative arrival time value corresponding the first antenna port of the first CSI-RS resource, a relative arrival time value corresponding the second antenna port of the first CSI-RS resource, …, and/or a relative arrival time value corresponding the N-th antenna port of the first CSI-RS resource.

In some embodiments, the UE might not report the relative arrival time value corresponding to the reference antenna port. In this example method, the measurement result can also be relative phase or frequency offset.

In an example, the UE can be configured with a first CSI-RS resource with N antenna ports to measure the relative arrival time of antenna ports. The UE can be requested to determine one CSI-RS antenna port that would be used as the reference antenna port for the UE to calculate the measurement result of relative arrival time. The UE can be requested to report the following information: one indicator of an antenna port to indicate the reference antenna port, a relative arrival time value corresponding the first antenna port of the first CSI-RS resource, a relative arrival time value corresponding the second antenna port of the first CSI-RS resource, …, and/or a relative arrival time value corresponding the N-th antenna port of the first CSI-RS resource.

In some embodiments, the UE might not report the relative arrival time value corresponding to the reference antenna port. In this example method, the measurement result can also be relative phase or frequency offset.

In summary, with the proposed method, the NR system can effectively adjust the timing and frequency synchronization between TRPs and thus the performance coherent joint transmission would be improved significantly.

Commercial interests for some embodiments are as follows. 1. Solve issues in the prior art and other issues. 2. Provide an exemplary technique by which a user equipment (UE) may measure and report relative time and frequency synchronization offset to assist inter-transmission/reception point (TRP) calibration. 3. Adjust timing and frequency synchronization between TRPs. 4. Improve a performance coherent joint transmission. 5. Provide a good communication performance. 6. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of wireless communication are considered for standardizing.

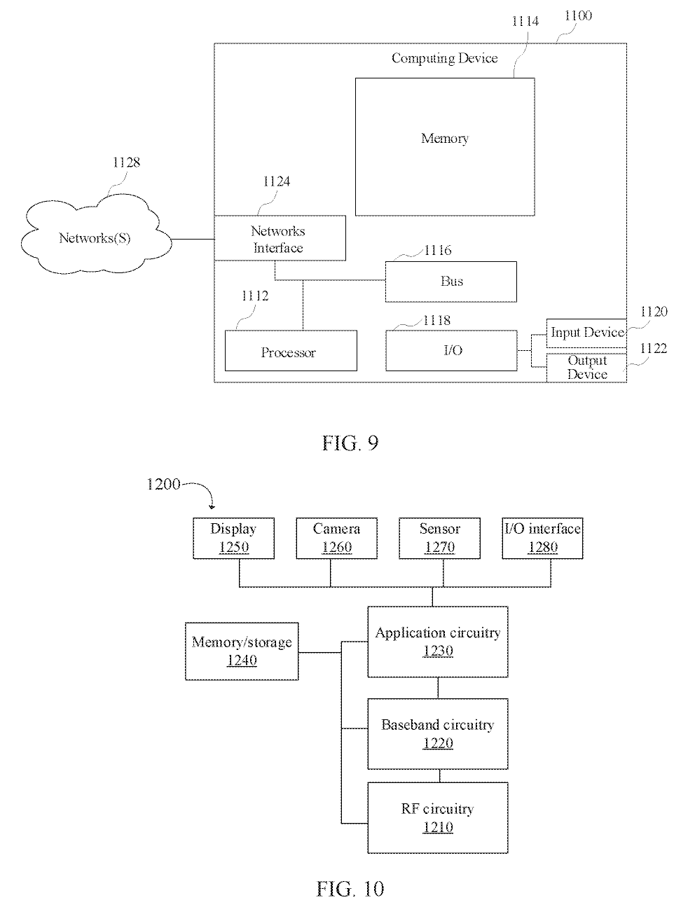

FIG. 9 is an example of a computing device 1100 according to an embodiment of the present disclosure. Any suitable computing device can be used for performing the operations described herein. For example, FIG. 9 illustrates an example of the computing device 1100 that can implement some embodiments of FIG. 1 to FIG. 8 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1 to FIG. 8. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 10 is a block diagram of an example of a communication system 1200 according to an embodiment of the present disclosure. Embodiments described herein may be implemented into the communication system 1200 using any suitably configured hardware and/or software. FIG. 10 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1 to FIG. 8. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1 to FIG. 8 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method of wireless communication of a user equipment (UE), comprising:
receiving a request to measure one or more offset values between a first reference signal (RS) associated with a first transmission/reception point (TRP) and a second RS associated with a second TRP from a base station; and
transmitting a measurement report to the base station, wherein the measurement report indicates the one or more offset values between the first RS associated with the first TRP and the second RS associated with the second TRP.

2. The method of claim 1, further comprising:
measuring the first RS associated with the first TRP and the second RS associated with the second TRP.

3. The method of claim 1, further comprising:
calculating the one or more offset values between the first RS associated with the first TRP and the second RS associated with the second TRP.

4. The method of claim 1, wherein the one or more offset values comprise one or more time difference values, one or more frequency offset values, or one or more phase offset values.

5. The method of claim 1, wherein the first RS comprises a first channel state information reference signal (CSI-RS) resource or first second synchronization signal (SS)/physical broadcast channel (PBCH) blocks, and the second RS comprises a second CSI-RS resource or second SS/PBCH blocks.

6. The method of claim 5, wherein the measurement report is relative to an arrival time of the first CSI-RS resource and the second CSI-RS resource, an arrival time of the first SS/PBCH blocks and the second SS/PBCH blocks, a frequency offset of the first CSI-RS resource and the second CSI-RS resource, a frequency offset of the first SS/PBCH blocks and the second SS/PBCH blocks, a phase of the first CSI-RS resource and the second CSI-RS resource, or a phase of the first SS/PBCH blocks and the second SS/PBCH blocks.

7. The method of claim 5, wherein the first CSI-RS resource is configured with multiple antenna ports, and the second CSI-RS resource is configured with multiple antenna ports.

8. The method of claim 7, wherein the measurement report is relative to an indicator of the first CSI-RS resource and the second CSI-RS resource, an indicator of the first SS/PBCH block and the second SS/PBCH block, or an indicator of a first CSI-RS resource antenna port index and a second CSI-RS resource antenna port index.

9. The method of claim 1, wherein transmitting the measurement report to the base station comprises:
transmitting the measurement report to the base station through a media access control (MAC) control element (CE) message, an uplink control information (UCI) through a physical uplink control channel (PUCCH) transmission, a periodic manner, a semi-persistent manner, an aperiodic manner, or a UE-driven mode.

10. A user equipment (UE), comprising:
a memory;
a transceiver; and
a processor coupled to the memory and the transceiver;
wherein the UE is configured to: receive a request to measure one or more offset values between a first reference signal (RS) associated with a first transmission/reception point (TRP) and a second RS associated with a second TRP from a base station; and
transmit a measurement report to the base station, wherein the measurement report indicates the one or more offset values between the first RS associated with the first TRP and the second RS associated with the second TRP.

11. The UE of claim 10, wherein the UE is further configured to:
measure the first RS associated with the first TRP and the second RS associated with the second TRP.

12. The UE of claim 10, wherein the UE is further configured to:
calculate the one or more offset values between the first RS associated with the first TRP and the second RS associated with the second TRP.

13. The UE of claim 10, wherein the one or more offset values comprise one or more time difference values, one or more frequency offset values, or one or more phase offset values.

14. The UE of claim 10, wherein the first RS comprises a first channel state information reference signal (CSI-RS) resource or first second synchronization signal (SS)/physical broadcast channel (PBCH) blocks, and the second RS comprises a second CSI-RS resource or second SS/PBCH blocks.

15. The UE of claim 14, wherein the measurement report is relative to an arrival time of the first CSI-RS resource and the second CSI-RS resource, an arrival time of the first SS/PBCH blocks and the second SS/PBCH blocks, a frequency offset of the first CSI-RS resource and the second CSI-RS resource, a frequency offset of the first SS/PBCH blocks and the second SS/PBCH blocks, a phase of the first CSI-RS resource and the second CSI-RS resource, or a phase of the first SS/PBCH blocks and the second SS/PBCH blocks.

16. A base station, comprising:
a memory;
a transceiver; and
a processor coupled to the memory and the transceiver;
wherein the base station is configured to: transmit a request to measure one or more offset values between a first reference signal (RS) associated with a first transmission/reception point (TRP) and a second RS associated with a second TRP to a user equipment; and
receive a measurement report from the user equipment, wherein the measurement report indicates the one or more offset values between the first RS associated with the first TRP and the second RS associated with the second TRP.

17. The base station of claim 16, wherein the base station is further configured to:
perform an inter-TRP calibration of the first TRP and the second TRP based on the measurement report.

18. The base station of claim 16, wherein the one or more offset values comprise one or more time difference values, one or more frequency offset values, or one or more phase offset values.

19. The base station of claim 16, wherein the first RS comprises a first channel state information reference signal (CSI-RS) resource or first second synchronization signal (SS)/physical broadcast channel (PBCH) blocks, and the second RS comprises a second CSI-RS resource or second SS/PBCH blocks.

20. The base station of claim 19, wherein the measurement report is relative to an arrival time of the first CSI-RS resource and the second CSI-RS resource, an arrival time of the first SS/PBCH blocks and the second SS/PBCH blocks, a frequency offset of the first CSI-RS resource and the second CSI-RS resource, a frequency offset of the first SS/PBCH blocks and the second SS/PBCH blocks, a phase of the first CSI-RS resource and the second CSI-RS resource, or a phase of the first SS/PBCH blocks and the second SS/PBCH blocks.
